(19) United States
(12) Patent Application Publication
(10) Pub. No.: US 2025/0353039 A1
(43) Pub. Date: Nov. 20, 2025

(54) COLLECTION DEVICE AND COLLECTION METHOD FOR VIBRATION SIFTER

(71) Applicant: NISSHIN FLOUR MILLING INC., Tokyo (JP)

(72) Inventor: Takashi SHIRAI, Saitama, Tokyo (JP)

(73) Assignee: NISSHIN FLOUR MILLING INC., Tokyo (JP)

(21) Appl. No.: 18/868,847

(22) PCT Filed: Apr. 5, 2023
(86) PCT No.: PCT/JP2023/014034

§ 371 Date: Aug. 8, 2025

(30) Foreign Application Priority Data
May 31, 2022 (JP) 2022-088225

(51) Int. Cl. B07B 1/50; B07B 1/28

(52) U.S. Cl. CPC B07B 1/50; B07B 1/28

(57) ABSTRACT

A collection device for vibration sifter according to the present invention is a collection device for vibration sifter for collecting on-sifter powder remaining on an upper surface of a sifter of a vibration sifter device. The collection device for vibration sifter includes a hollow shaft in a hollow shape that is disposed above the sifter located within a surface along a horizontal plane as an axis in a direction along a vertical direction, a nozzle that is attached to an lower end of the hollow shaft, elongates in a radial direction from the hollow shaft, includes a first suction port on a bottom surface and a second suction port on a side surface at an end of elongation in the radial direction, and includes a cavity communicating with the hollow space of the hollow shaft, a suction unit that sucks air inside the cavity of the nozzle and inside the hollow space of the hollow shaft, and a suction controller that controls the suction unit to suck the air when the sifter of the vibration sifter device is vibrating.

### TECHNICAL FIELD

The present invention relates to a collection device for vibration sifter, which collects on-sifter powder remaining on an upper surface of a sifter of a vibration sifter device, and a collection method by using the collection device for vibration sifter.

### BACKGROUND ART

It is known that there are vibration sifter devices, which separate, by feeding powder on a sifter and vibrating a sifter, powder passing through holes of the sifter (powder of which particle size is smaller than the size of hole) from on-sifter powder remaining on the sifter (powder of which particle size is larger than the size of the hole).

With regard to the vibration sifter device as described above, for the purpose of suppression of clogging of the sifter, etc., there are several proposals, such as a vibration sifter cleaning system to clean a surface the sifter by brush (for example, see Patent Literature 1), or a vibration sifter device, which eliminates powder particles sticking to the sifter by spraying compressed air to the sifter surface (for example, see Patent Literature 2).

### CITATION LIST

### Patent Literature

Patent Literature 1: JP 2014-532557A

Patent Literature 2: JP 1993-146757A

### SUMMARY OF INVENTION

### Technical Problem

With this regard, according to devices of Patent Document 1 and Patent Document 2, clogging of sifter is suppressed by brushing the sifter surface or by blowing off the on-sifter powder remaining on the upper surface of the sifter, but these devices do not accomplish collection of the on-sifter powder. For the purpose of prevention of clogging of the sifter for a long period of time, it is desirable to collect the on-sifter powder regularly.

It is an object of the present invention to provide a collection device for vibration sifter, which can favorably collect on-sifter powder remaining on an upper surface of a sifter of a vibration sifter device, and a collection method by using the collection device for vibration sifter.

### Solution to Problem

A collection device for vibration sifter according to the present invention is a collection device for vibration sifter for collecting on-sifter powder remaining on an upper surface of a sifter of a vibration sifter device. The collection device for vibration sifter includes a hollow shaft in a hollow shape that is disposed above the sifter located within a surface along a horizontal plane as an axis in a direction along a vertical direction, a nozzle that is attached to an lower end of the hollow shaft, elongates in a radial direction from the hollow shaft, includes a first suction port on a bottom surface and a second suction port on a side surface at an end of elongation in the radial direction, and includes a cavity communicating with the hollow space of the hollow shaft, a suction unit that sucks air inside the cavity of the nozzle and inside the hollow space of the hollow shaft, and a suction controller that controls the suction unit to suck the air when the sifter of the vibration sifter device is vibrating.

The collection device for vibration sifter according to the present invention further includes an elevation unit that moves the hollow shaft in upward/downward directions.

The collection device for vibration sifter according to the present invention further includes a rotation unit that rotates the hollow shaft so that the hollow shaft serves as an axis.

The collection device for vibration sifter according to the present invention is attached to the vibration sifter device not including a discharge port for discharging the on-sifter powder.

The collection device for vibration sifter according to the present invention is that the first suction port and the second suction port are integrally formed.

A collection method according to the present invention is a collection method for collecting on-sifter powder remaining on an upper surface of a sifter of a vibration sifter device by using the collection device for vibration sifter of the present invention. The collection method includes a downward movement step that moves, when the sifter of the vibration sifter device is vibrating, the hollow shaft in a downward direction, by an elevation unit for moving the hollow shaft of the collection device for vibration sifter in upward/downward directions, in a state that the second suction port of the nozzle of the collection device for vibration sifter faces outward of the vibration sifter device, a first determination step that determines whether or not a first predetermined time has passed since finish of movement of the hollow shaft in the downward direction in the downward movement step, a first rotation step that rotates, after passing of the first predetermined time, the hollow shaft by a rotation unit of the collection device for vibration sifter so that the hollow shaft serves as an axis, until the second suction port of the nozzle faces inward of the vibration sifter device, a second determination step that determines whether or not a second predetermined time has passed since finish of rotation of the hollow shaft in the first rotation step, a second rotation step that rotates, after passing of the second predetermined time, the hollow shaft by the rotation unit so that the hollow shaft serves as the axis, until the second suction port of the nozzle faces outward of the vibration sifter device, an upward movement step that moves, in a state that the second suction port of the nozzle faces outward of the vibration sifter device, the hollow shaft in an upward direction by the elevation unit, and a suction step that sucks, during at least the first predetermined time and the second predetermined time, air inside the cavity of the nozzle and inside the hollow space of the hollow shaft, by the suction unit of the collection device for vibration sifter.

### Advantageous Effects of Invention

According to the present invention, it is possible to provide a collection device for vibration sifter, which can favorably collect on-sifter powder remaining on an upper surface of a sifter of a vibration sifter device, and a collection method by using the collection device for vibration sifter.

### BRIEF DESCRIPTION OF DRAWINGS

FIG. 1 is a view showing a configuration of a collection device for vibration sifter according to an embodiment.

FIG. 2 is a view showing a configuration of the collection device for vibration sifter according to the embodiment.

FIG. 3 is a view showing a configuration of the collection device for vibration sifter according to the embodiment.

FIG. 4 are views showing a configuration of a nozzle according to the embodiment.

FIG. 5 is a block diagram showing a system configuration of the collection device for vibration sifter according to the embodiment.

FIG. 6 is a flow chart explaining a collection method for collecting on-sifter powder remaining on an upper surface of a sifter by using the collection device for vibration sifter according to the embodiment.

FIG. 7 is a view explaining flows of powder on the sifter during vibration.

FIG. 8 are views showing configurations of a nozzle according to other embodiments.

FIG. 9 are views showing configurations of a first suction port according to other embodiments.

FIG. 10 is a view showing a configuration of a first suction port according to another embodiment.

FIG. 11 are views showing configurations of a second suction port according to other embodiments.

### DESCRIPTION OF EMBODIMENT

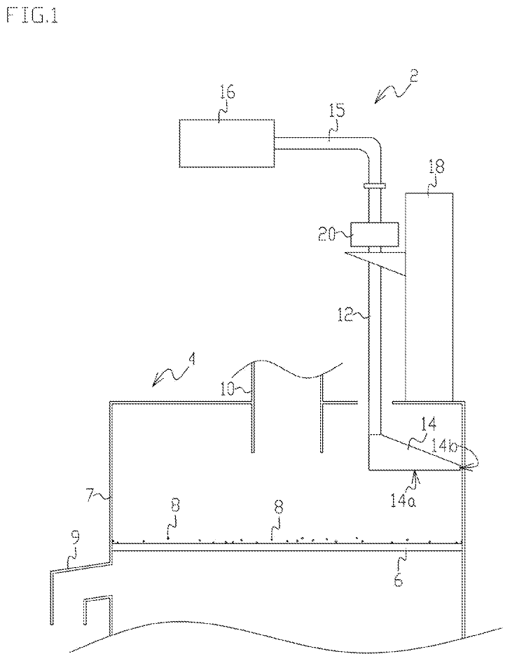

Now, a collection device for vibration sifter according to embodiments will be explained with reference to drawings. FIGS. 1 to 3 are views showing a configuration of the collection device for vibration sifter according to an embodiment. A collection device for vibration sifter 2 according to the embodiment is a device for collecting on-sifter powder 8 remaining on an upper surface of a sifter 6 of a vibration sifter device 4, and as illustrated in FIGS. 1 to 3, includes a hollow shaft 12, a nozzle 14, a suction unit 16, an elevation unit 18, and a rotation unit 20. It should be noted that, in the present embodiment, the vibration sifter device 4 includes a powder discharge port 9 for discharging powder passed through the sifter 6 (under-sifter powder), but since the on-sifter powder 8 remaining on the upper surface of the sifter 6 is collected by the collection device for vibration sifter 2, there is no powder discharge port for discharging the on-sifter powder 8. However, it is also possible for the collection device for vibration sifter 2 according to the present invention, to be attached to a vibration sifter device 4 including a powder discharge port for discharging the on-sifter powder 8.

The sifter 6 is positioned within a surface along a horizontal plane (within a horizontal plane or within a substantially horizontal plane), and sifters powder, which has been sifted from a powder feeding port 10 of the vibration sifter device 4, by vibration. According to the present embodiment, a shape of the sifter 6 is in a circular shape, but it is also possible to be formed in another shape, such as a polygonal shape including a quadrangular shape, or an elliptical shape.

As illustrated in FIGS. 1 to 3, the hollow shaft 12 has a configuration that a direction along the vertical direction (in the vertical direction or substantially in the vertical direction) serves as an axis, and is disposed, in an area not colliding with the powder feeding port 10, and also above the sifter 6. The hollow shaft 12 is in a hollow stick shape, and is configured to be movable in upward/downward directions by the elevation unit 18, and also to be rotatable by the rotation unit 20. The hollow shaft 12 does not collide, even in the upward/downward or rotation movement, with the powder feeding port 10. Air in the hollow of the hollow shaft 12 is sucked by the suction unit 16, at least while the on-sifter powder 8 is collected by the collection device for vibration sifter 2.

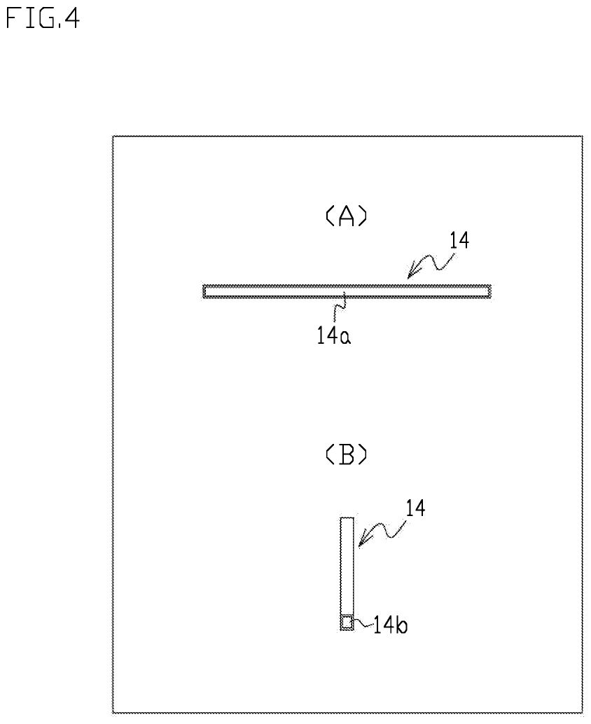

As illustrated in FIGS. 1 to 3, the nozzle 14 is attached to the lower end of the hollow shaft 12, and elongates in a radial direction (a direction along the horizontal plane) from the hollow shaft 12. As illustrated in FIGS. 1 to 3, a side surface of the nozzle 14 (a side surface of the nozzle 14 as viewed in a direction from a position in front of a drawing sheet of FIG. 1) is in a shape of gradually becoming thinner in the radial direction from the hollow shaft 12, that is, in a triangular shape. FIG. 4 (A) is a bottom view showing a configuration of the nozzle 14 (a view of the nozzle 14 as viewed from a lower side toward an upper side of the drawing sheet of FIG. 1), and FIG. 4 (B) is a side view showing a configuration of the nozzle 14 (a view of the nozzle 14 as viewed from the left side toward the right side of the drawing sheet of FIG. 1). As illustrated in FIG. 4 (A), a first suction port 14a is provided on a rectangular-shaped bottom surface of the nozzle 14. The first suction port 14a is an opening, in which two panel members are disposed with a distance therebetween, so that a predetermined thickness is secured, and so that a whole bottom surface of the nozzle 14 is fully open, whereby the on-sifter powder 8 remaining on the upper surface of the sifter 6 is sucked.

Moreover, as illustrated in FIG. 4 (B), a second suction port 14b is provided, at a tip end of the nozzle 14, and also at a side surface of an elongating end of the hollow shaft 12 in the radial direction. The second suction port 14b is an opening, in which two panel members are disposed with a distance therebetween, so that a predetermined thickness is secured, and so that a whole tip end of the nozzle 14 is fully open, whereby the on-sifter powder 8, remaining on an inner wall surface of a barrel 7 standingly provided around a rim of the sifter 6, is sucked. In the present embodiment, the first suction port 14a and the second suction port 14b are integrally formed to be connected to each other, but it is also possible to provide independent openings. The inside of the nozzle 14 is a cavity, which communicates the first suction port 14a and the second suction port 14b, with a hollow space of the hollow shaft 12. The air inside the nozzle 14 is sucked by the suction unit 16.

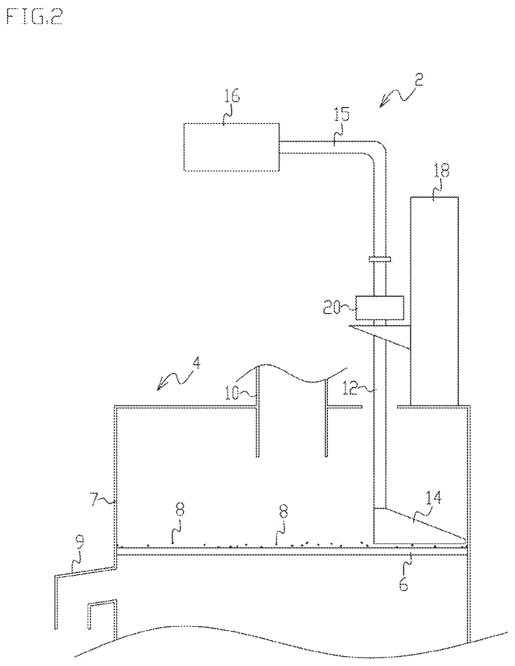

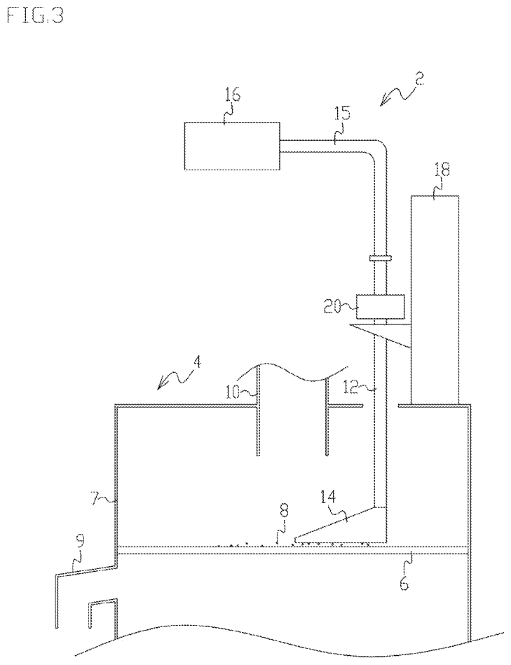

While the vibration sifter device 4 is sifting the powder by the sifter 6, the hollow shaft 12 and the nozzle 14 are evacuating at a position as illustrated in FIG. 1 (above the sifter 6). Moreover, after the vibration sifter device 4 finishes sifting of the powder by the sifter 6, the hollow shaft 12 and nozzle 14 moves in a downward direction until reaching a position as illustrated in FIG. 2 (a proximity position above the sifter 6). Note that, in the position as illustrated in FIG. 2, there is a clearance provided between the tip end of the second suction port 14b of the nozzle 14 and the inner wall surface of the barrel 7, so that they do not collide with each other even while the sifter 6 is vibrating. During collection of the on-sifter powder 8 remaining on the upper surface of the sifter 6, the hollow shaft 12 and the nozzle 14 remain at the position as illustrated in FIG. 2, and at a halfway of collection, they rotate substantially at angle of 180 degrees, until reaching a position as illustrated in FIG. 3. Until the collection of the on-sifter powder 8 remaining on the upper surface of the sifter 6 finishes, the hollow shaft 12 and the nozzle 14 remain at the position as illustrated in FIG. 3, and after finish of collection, they rotate until reaching the position as illustrated in FIG. 2, and moves in an upward direction until reaching the position as illustrated in FIG. 1.

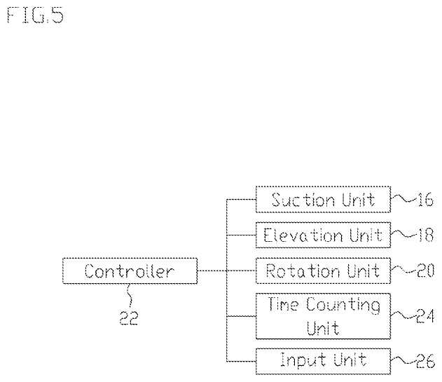

The suction unit 16 is connected to a top or a center of the hollow shaft 12, or to the hollow shaft 12 via a hose 15, etc., and sucks the air in the cavity of the nozzle 14 and the hollow space of the hollow shaft 12. On/off operation of suction by the suction unit 16 is controlled by a controller (control unit) 22 (see FIG. 5). After finish of sifting by the vibration sifter device 4 and also during vibration of the sifter 6 of the vibration sifter device 4, the controller 22 controls the suction unit 16 to suck the air inside the cavity of the nozzle 14 and inside the hollow space of the hollow shaft 12. Note that, it is desirable that the suction unit 16 includes a bag filter.

The elevation unit 18 is disposed at an outside of the vibration sifter device 4, and moves the hollow shaft 12, and further the nozzle 14 attached to the lower end of the hollow shaft 12, in upward/downward directions. The driving of the elevation device 18 is controlled by the controller 22. When the collection device for vibration sifter 2 collects the on-sifter powder 8 remaining on the upper surface of the sifter 6, in accordance with an instruction of the controller 22, the elevation unit 18 moves the hollow shaft 12 and the nozzle 14 in a downward direction, from the position as illustrated in FIG. 1, to the position as illustrated in FIG. 2. Moreover, after the collection device for vibration sifter 2 finishes the collection, in accordance with an instruction of the controller 22, the elevation unit 18 moves the hollow shaft 12 and the nozzle 14 in an upward direction, from the position as illustrated in FIG. 2, to the position as illustrated in FIG. 1.

The rotation unit 20 is disposed at an outside of the vibration sifter device 4, and rotates the hollow shaft 12, and further the nozzle 14 attached to the lower end of the hollow shaft 12, so that the hollow shaft 12 serves as an axis. The driving of the rotation device 20 is controlled by the controller 22. After the collection device for vibration sifter 2 finishes collection of the on-sifter powder 8 remaining in an outer area (not in a center area) on the upper surface of the sifter 6, in accordance with an instruction of the controller 22, the rotation unit 20 rotates the hollow shaft 12 and the nozzle 14, from the position as illustrated in FIG. 2, to the position as illustrated in FIG. 3. Moreover, after the collection device for vibration sifter 2 finishes collection of the on-sifter powder 8 remaining in the center area on the upper surface of the sifter 6, in accordance with an instruction of the controller 22, the rotation unit 20 rotates the hollow shaft 12 and the nozzle 14, from the position as illustrated in FIG. 3, to the position as illustrated in FIG. 2.

FIG. 5 is a block diagram showing a system configuration of the collection device for vibration sifter 2 according to the embodiment. As illustrated in FIG. 5, the collection device for vibration sifter 2 includes the controller 22 for integrally controlling respective units of the collection device for vibration sifter 2. The controller 22 is in connection with the suction unit 16, the elevation unit 18, the rotation unit 20, a time counting unit 24, and an input unit 26.

The time counting unit 24 is a clock or a timer, which counts a first predetermined time and a second predetermined time. After the hollow shaft 12 and the nozzle 14 move to the position as illustrated in FIG. 2, in accordance with an instruction of the controller 22, the time counting unit 24 starts counting of the first predetermined time. After passing of the first predetermined time, the time counting unit 24 transmits information to the controller 22, to notify that the first predetermined time has passed. Moreover, after the hollow shaft 12 and the nozzle 14 move to the position as illustrated in FIG. 3, in accordance with an instruction of the controller 22, the time counting unit 24 starts counting of the second predetermined time. Then, after passing of the second predetermined time, the time counting unit 24 transmits information to the controller 22, to notify that the second predetermined time has passed. Note that, the first predetermined time and the second predetermined time are respectively inputted, via the input unit 26, etc., as the time required for collecting the on-sifter powder 8, and are stored in a storage, etc. (not shown).

The input unit 26 is an input device such as a touch panel, a keyboard, and/or a mouse, etc., and is operated by a user. The information inputted by the user via the input unit 26 is transmitted to the controller 22.

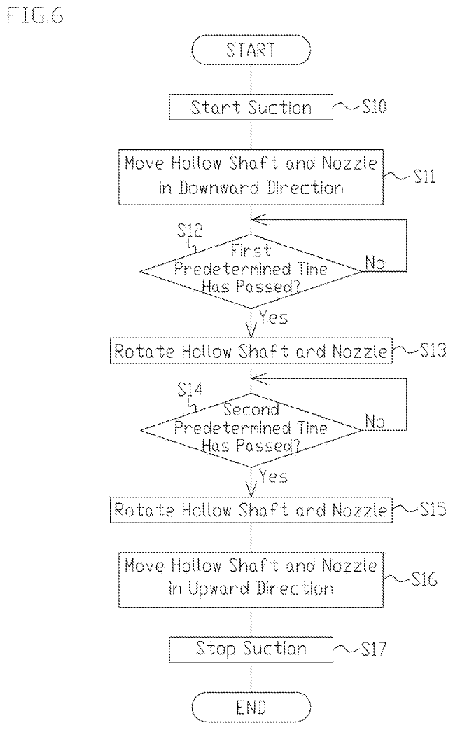

Next, a collection method for collecting the on-sifter powder 8 remaining on the upper surface of the vibration sifter device 4, by the collection device for vibration sifter 2 according to the present embodiment, will be explained. FIG. 6 is a flow chart explaining process steps executed by the controller 22 for collecting the on-sifter powder 8 remaining on the upper surface of the sifter 6, after the vibration sifter device 4 finishes the sifting.

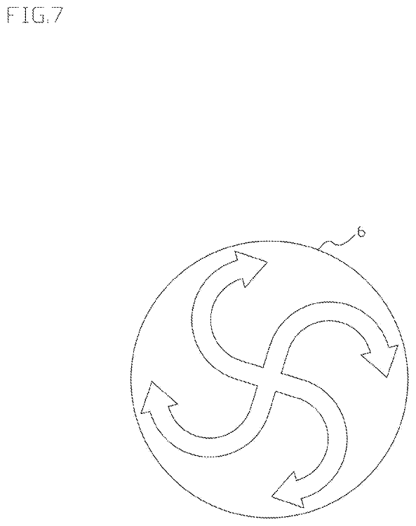

First, while the sifter 6 of the vibration sifter device 4 is vibrating, the controller 22 starts suction by the suction unit 16, of the air inside the cavity of the nozzle 14 and inside the hollow space of the hollow shaft 12 (step S10). Here, a plurality of vibrators (not shown) is attached to the sifter 6 of the vibration sifter device 4, and vibration of each vibrator causes vibration of the sifter 6. The frequency and phase of vibration of each vibrator may be varied, and an appropriate value of frequency is selected in accordance with the characteristics, etc., of powder to be sifted. Moreover, by setting difference between the phases of vibration of the respective vibrators, it is possible to control a direction in which the powder on the upper surface of the sifter 6 flows during vibration. For example, it is possible to move the powder, in a direction of gathering toward the center of the sifter 6, or in a direction of gathering toward the outer periphery of the sifter 6, or in a direction of rotating spirally around the center of the sifter 6 serving as an axis, etc. In the present embodiment, while the sifter 6 is vibrating during sifting by the vibration sifter device 4 and during collecting of the on-sifter powder by the collection device for vibration sifter 2, the phase of vibration of each of the vibrators (phase difference) is appropriately set so that the flow of the powder becomes in directions shown by arrows of FIG. 7, that is, directions rotating spirally around the center of the sifter 6 serving as the axis. Note that, during sifting by the vibration sifter device 4, the hollow shaft 12 and the nozzle 14 of the collection device for vibration sifter 2 are evacuating at the position as illustrated in FIG. 1.

Next, as illustrated in FIG. 1 and FIG. 2, the controller 22 moves the hollow shaft 12 and the nozzle 14 by the elevation unit 18, in the downward direction from the position as illustrated in FIG. 1, to the position as illustrated in FIG. 2, in a state that the second suction port 14b of the nozzle 14 faces outward of the vibration sifter device 4 (step S11). Since the hollow shaft 12 moves in the downward direction in a state that the second suction port 14b of the nozzle 14 faces outward of the vibration sifter device 4, the nozzle 14 does not collide with the powder feeding port 10 of the vibration sifter device 4.

Next, the controller 22 determines whether or not the first predetermined time has passed since finish of the downward movement of the hollow shaft 12 and the nozzle 14 at step S11 (step S12). Specifically, after the finish of the downward movement of the hollow shaft 12 and the nozzle 14 at step S11, the controller 22 instructs the time counting unit 24 to start counting of the first predetermined time, and after passing of the first predetermined time, receives a first predetermined time passed information from the time counting unit 24, notifying that the first predetermination time has passed. Note that, while the controller 22 determines that the first predetermined time has not passed (step S12: NO), that is, during the time until the first predetermined time has passed, since the suction by the suction unit 16 is continuing, the on-sifter powder 8 remaining on the upper surface of the sifter 6 is collected by being sucked into the first suction port 14a, and the on-sifter powder 8 remaining on the inner wall surface of the barrel 7 is collected by being sucked into the second suction port 14b. The first predetermined time is appropriately determined in accordance with the characteristics of powder, the volume of powder to be sifted, etc., and is inputted, for example by the user via the input unit 26, and is stored in the storage, etc. The controller 22 acquires the first predetermined time from information stored in the storage, etc.

Note that, the on-sifter powder 8 remaining on the upper surface of the sifter 6 moves rotationally in the shape of spiral on the upper surface of the sifter 6 as illustrated in FIG. 7, and the on-sifter powder 8 that reached below the first suction port 14a during rotational movement, is collected by being sucked into the first suction port 14a. Similarly, the on-sifter powder 8 that reached in the vicinity of the second suction port 14b (the inner wall surface of the barrel 7) during rotational movement, is collected by being sucked into the second suction port 14b. During the first predetermined time, by continuing the collection, the whole amount of, or substantially whole amount of the on-sifter powder 8 on the outer periphery of the upper surface of the sifter 6 and on the inner wall surface of the barrel 7, is collected.

Next, after passing of the first predetermined time (step S12: YES), the controller 22 moves the hollow shaft 12 by the rotation unit 20 so that the hollow shaft 12 serves as the axis, substantially at angle of 180 degrees (substantially half-rotation), from the position as illustrated in FIG. 2, to the position as illustrated in FIG. 3, that is, until the second suction port 14b of the nozzle 14, which has been facing outward, faces inward of the vibration sifter device 4 (step S13). Since the nozzle 14 is disposed at a proximity position above the sifter 6, the nozzle 14 does not collide with the powder feeding port 10 of the vibration sifter device 4.

Next, the controller 22 determines whether or not the second predetermined time has passed since finish of rotation of the hollow shaft 12 at step S13 (step S14). Specifically, after the finish of rotation of the hollow shaft 12 at step S13, the controller 22 instructs the time counting unit 24 to start counting of the second predetermined time, and after passing of the second predetermined time, receives a second predetermined time passed information from the time counting unit 24, notifying that the second predetermination time has passed. Note that, while the controller 22 determines that the second predetermined time has not passed (step S14: NO), that is, during the time until the second predetermined time has passed, since the suction by the suction unit 16 is continuing, the on-sifter powder 8 remaining in an inner area on the upper surface of the sifter 6 is collected by being sucked into the first suction port 14a. The on-sifter powder 8 remaining on the upper surface of the sifter 6 moves rotationally in the shape of spiral on the upper surface of the sifter 6 as illustrated in FIG. 7, and the on-sifter powder 8 that reached below the first suction port 14a during rotational movement, is collected by being sucked into the first suction port 14a. During the second predetermined time, by continuing the collection, the whole amount of, or substantially whole amount of the on-sifter powder 8 remaining in the center area on the upper surface of the sifter 6, is collected. The second predetermined time is appropriately determined in accordance with the characteristics of powder, the volume of powder to be sifted, etc., and is inputted, for example by the user via the input unit 26, and is stored in the storage, etc. The controller 22 acquires the second predetermined time from information stored in the storage, etc.

Next, after passing of the second predetermined time (step S14: YES), the controller 22 moves the hollow shaft 12 by the rotation unit 20 so that the hollow shaft 12 serves as the axis, substantially at angle of 180 degrees (substantially half-rotation), from the position as illustrated in FIG. 3, to the position as illustrated in FIG. 2, that is, until the second suction port 14b of the nozzle 14, which has been facing inward, faces outward of the vibration sifter device 4 (step S15). Then, in a state that the second suction port 14b of the nozzle 14 faces outward of the vibration sifter device 4, the controller 22 moves the hollow shaft 12 and the nozzle 14 in an upward direction by the elevation unit 18, from the position as illustrated in FIG. 2, to the position as illustrated in FIG. 1 (step S16). Finally, the controller 22 stops suction by the suction unit 16, of the air inside the cavity of the nozzle 14 and inside the hollow space of the hollow shaft 12 (step S17).

According to the collection device for vibration sifter 2, and the collection method by using the collection device for vibration sifter 2 of the present embodiment, it is possible to favorably collect the on-sifter powder 8 remaining on the upper surface of the sifter 6. Moreover, since the hollow shaft 12 and the nozzle 14 move to the proximity position above sifter 6 only while the collection device for vibration sifter 2 is performing the collection, and evacuates to the position above the sifter 6 when the collection is not performed, they do not interfere with sifting by the vibration sifter device 4. Moreover, since the hollow shaft 12 and the nozzle 14 rotate corresponding to the need, they do not collide with the powder feeding port 10, etc., of the vibration sifter device 4. Moreover, in addition to the first suction port 14a, since the second suction port 14b is also provided, it is possible to collect, not only the on-sifter powder 8 remaining on the upper surface of the sifter 6, but also the on-sifter powder 8 remaining on the inner wall surface of the barrel 7.

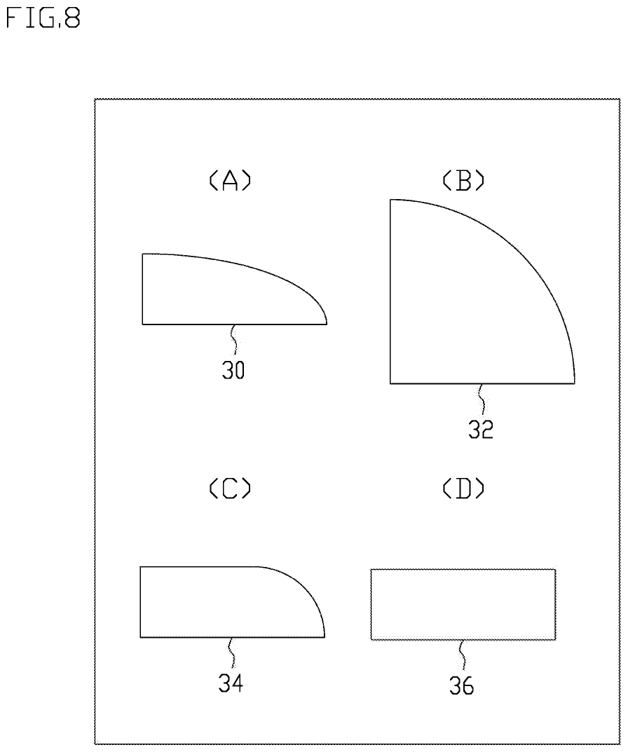

Moreover, instead of the nozzle 14 according to the present embodiment, it is also possible to include a nozzle, of which side surface is in any shape other than triangle, such as a nozzle 30 in a shape as illustrated in FIG. 8 (A), that is the shape in which an ellipse is divided into a quarter, or a nozzle 32 as illustrated in FIG. 8 (B), that is in a quadrant shape (circular sector shape), or a nozzle 34 as illustrated in FIG. 8 (C), that is in a shape in combination of rectangle with quadrant, or a nozzle 36 as illustrated in FIG. 8 (D), that is in a rectangular shape.

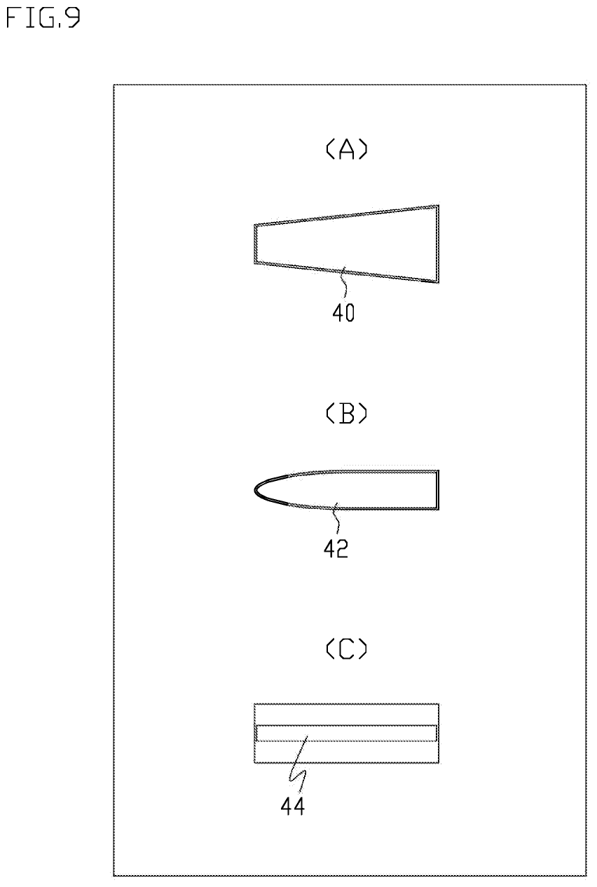

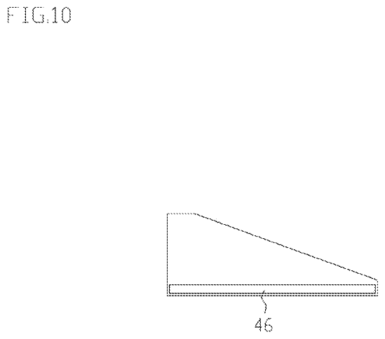

Moreover, instead of the first suction port 14a according to the present embodiment, it is also possible to include a first suction port, of which shape is in any shape other than rectangle, such as a first suction port 40 as illustrated in FIG. 9 (A), that is in a trapezoid shape, or a first suction port 42 as illustrated in FIG. 9 (B), that is in a shape in combination of half circle with rectangle, etc. Moreover, instead of the first suction port 14a according to the present embodiment, it is also possible to include a first suction port, in which the bottom surface of the nozzle is partially open, such as a first suction port 44 in a shape of slit, as illustrated in FIG. 9 (C). Moreover, instead of the first suction port 14a according to the present embodiment, it is also possible to include a first suction port, in which any surface other than the bottom surface of the nozzle is partially open, such as a first suction port 46 as illustrated in FIG. 10, in which a slit-shaped opening is provided at a lower part of one of the side surfaces. In this case, the first suction port may be formed by openings, in which, a part of one of the side surfaces of the nozzle, and at least a part of the bottom surface of the nozzle, are both open, but it is more preferable that the first suction port is formed by an opening, in which a part of one of the side surfaces of the nozzle is only open. Moreover, the side surface on which the first suction port is provided, is a side surface opposing to the rotation direction in which the on-sifter powder 8 rotates spirally.

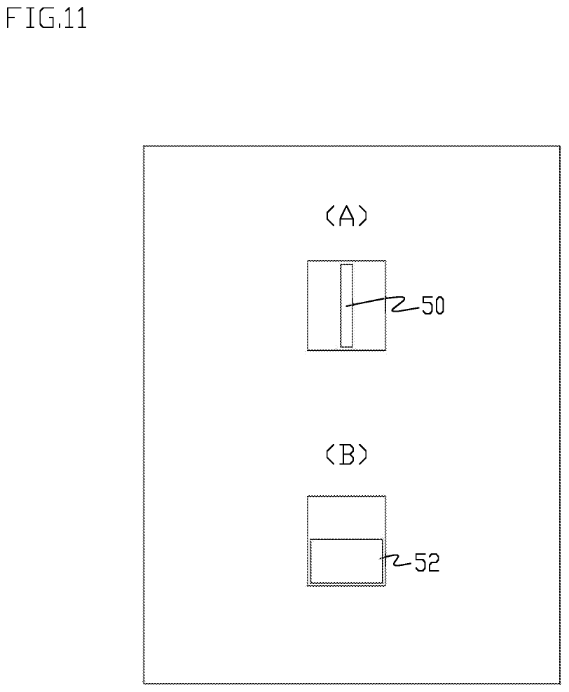

Moreover, instead of the second suction port 14b according to the present embodiment, it is possible to include a second suction port, in which a part of the tip end surface of a nozzle is open, such as a second suction port 50 in a shape of slit as illustrated in FIG. 11 (A), or a second suction port 52 in a rectangular shape as illustrated in FIG. 11 (B).

Moreover, in the present embodiment, the suction starts before the downward movement of the hollow shaft 12 and the nozzle 14, and after collection of the on-sifter powder 8, the suction stops after the upward movement of the hollow shaft 12 and the nozzle 14, but it is sufficient that the suction is performed at least during the first predetermined time and the second predetermined time. For example, it is also possible that, the suction starts after the downward movement of the hollow shaft 12 and the nozzle 14, and after collection of the on-sifter powder 8, the suction stops before the upward movement of the hollow shaft 12 and the nozzle 14. As another example, it is also possible that, after passing of the first predetermined time, the suction pauses temporarily, and after rotation of the nozzle 14, the suction resumes before the start of the second predetermined time.

Moreover, as another embodiment, it is also possible to have a configuration, in which the controller 22 acquires the finish of sifting by the vibration sifter device 4. For example, it is also possible that the controller 22 acquires information from the vibration sifter device 4, notifying the finish of sifting. As another example, it is also possible that the collection device for vibration sifter 2 separately includes a detection unit, such as a sensor or a camera, etc., for detecting the finish of sifting by the vibration sifter device 4. In this case, when the controller 22 acquires information from the vibration sifter device 4 or the detection unit, notifying the finish of sifting, then, the controller 22 starts the process of step S10 as illustrated in FIG. 6.

Similarly, as another embodiment, it is also possible to have a configuration, in which the controller 22 determines whether or not the sifter 6 is vibrating. That is, it is also possible that the controller 22 acquires information from the vibration sifter device 4, notifying whether or not the sifter 6 is vibrating. As another example, it is also possible that the collection device for vibration sifter 2 separately includes a vibration detection unit, such as a sensor or a camera, etc., for detecting whether or not the sifter 6 is vibrating. In this case, when the controller 22 acquires information from the vibration sifter device 4 or the vibration detection unit, notifying whether or not the sifter 6 is vibrating, and determines that the sifter 6 is vibrating, then, the controller 22 starts the process of step S10 as illustrated in FIG. 6.

Furthermore, in the present embodiment, the barrel 7 has been expressed as being integral with the sifter 6, but as another embodiment, it is also possible to have a configuration, in which the barrel 7 is separated into an upper section and a lower section, so that the vibration of the sifter 6 is not transmitted to the powder feeding port 10 or the elevation unit 18, etc.

### REFERENCE SIGNS LIST

2: Collection device for vibration sifter; 4: Vibration sifter device; 6: Sifter; 7: Barrel; 8: On-sifter powder; 9: Powder discharge port; 10: Powder feeding port; 12: Hollow shaft; 14: Nozzle; 14a: First suction port; 14b: Second suction port; 16: Suction unit; 18: Elevation unit; 20: Rotation unit; 22: Controller; 24: Time counting unit; 26: Input unit.

1. A collection device for vibration sifter, for collecting on-sifter powder remaining on an upper surface of a sifter of a vibration sifter device, comprising:
a hollow shaft in a hollow shape disposed above the sifter located within a surface along a horizontal plane as an axis in a direction along a vertical direction;
a nozzle, attached to a lower end of the hollow shaft, elongating in a radial direction from the hollow shaft, including a first suction port on a bottom surface and a second suction port on a side surface at an end of elongation in the radial direction, and including a cavity communicating with a hollow space of the hollow shaft;
a suction unit sucking air inside the cavity of the nozzle and inside the hollow space of the hollow shaft; and
a suction controller controlling the suction unit to suck the air when the sifter of the vibration sifter device is vibrating, wherein
the collection device for vibration sifter is attached to the vibration sifter device not including a discharge port for discharging the on-sifter powder.

2. The collection device for vibration sifter according to claim 1, further comprising:
an elevation unit moving the hollow shaft in upward/downward directions.

3. The collection device for vibration sifter according to claim 1, further comprising:
a rotation unit rotating the hollow shaft so that the hollow shaft serves as an axis.

4. The collection device for vibration sifter according to claim 7, wherein:
the collection device for vibration sifter is attached to the vibration sifter device not including a discharge port for discharging the on-sifter powder.

5. The collection device for vibration sifter according to claim 1, wherein:
the first suction port and the second suction port are integrally formed.

6. A collection method for collecting on-sifter powder remaining on an upper surface of a sifter of a vibration sifter device by using the collection device for vibration sifter according to claim 1, including:
a downward movement step moving, when the sifter of the vibration sifter device is vibrating, the hollow shaft in a downward direction, by an elevation unit for moving the hollow shaft of the collection device for vibration sifter in upward/downward directions, in a state that the second suction port of the nozzle of the collection device for vibration sifter faces outward of the vibration sifter device;
a first determination step determining whether or not a first predetermined time has passed since finish of movement of the hollow shaft in the downward direction in the downward movement step;
a first rotation step rotating, after passing of the first predetermined time, the hollow shaft by a rotation unit of the collection device for vibration sifter so that the hollow shaft serves as an axis, until the second suction port of the nozzle faces inward of the vibration sifter device;
a second determination step determining whether or not a second predetermined time has passed since finish of rotation of the hollow shaft in the first rotation step;
a second rotation step rotating, after passing of the second predetermined time, the hollow shaft by the rotation unit so that the hollow shaft serves as the axis, until the second suction port of the nozzle faces outward of the vibration sifter device;
an upward movement step moving, in a state that the second suction port of the nozzle faces outward of the vibration sifter device, the hollow shaft in an upward direction by the elevation unit; and
a suction step sucking, during at least the first predetermined time and the second predetermined time, air inside the cavity of the nozzle and inside the hollow space of the hollow shaft, by the suction unit of the collection device for vibration sifter.

7. A collection device for vibration sifter, for collecting on-sifter powder remaining on an upper surface of a sifter of a vibration sifter device, comprising:
a hollow shaft in a hollow shape disposed above the sifter located within a surface along a horizontal plane as an axis in a direction along a vertical direction;
a nozzle, attached to a lower end of the hollow shaft, elongating in a radial direction from the hollow shaft, including a first suction port, suctioning the on-sifter powder remaining on the upper surface of the sifter, on a bottom surface and a second suction port, suctioning the on-sifter powder remaining on an inner wall surface of a barrel standingly provided around a rim of the sifter, on a side surface at an end of elongation in the radial direction, and including a cavity communicating with a hollow space of the hollow shaft;
a suction unit sucking air inside the cavity of the nozzle and inside the hollow space of the hollow shaft; and
a suction controller controlling the suction unit to suck the air when the sifter of the vibration sifter device is vibrating.

8. The collection device for vibration sifter according to claim 7, further comprising:
an elevation unit moving the hollow shaft in upward/downward directions.

9. The collection device for vibration sifter according to claim 7, further comprising:
a rotation unit rotating the hollow shaft so that the hollow shaft serves as an axis.

10. The collection device for vibration sifter according to claim 7, wherein:
the first suction port and the second suction port are integrally formed.

11. The collection device for vibration sifter according to claim 8, further comprising:
a rotation unit rotating the hollow shaft so that the hollow shaft serves as an axis.

12. The collection device for vibration sifter according to claim 8, wherein:
the collection device for vibration sifter is attached to the vibration sifter device not including a discharge port for discharging the on-sifter powder.

13. The collection device for vibration sifter according to claim 8, wherein:
the first suction port and the second suction port are integrally formed.

14. The collection device for vibration sifter according to claim 2, further comprising:
a rotation unit rotating the hollow shaft so that the hollow shaft serves as an axis.

15. The collection device for vibration sifter according to claim 2, wherein:
the first suction port and the second suction port are integrally formed.
